(19) United States
(12) Patent Application Publication
(10) Pub. No.: US 2015/0258743 A1
(43) Pub. Date: Sep. 17, 2015

(54) METHOD FOR MOLDING A COMPOSITE MATERIAL WHEREIN A FIBER FABRIC IS TIGHTENED IN A RETENTION FRAME BEFORE INJECTION OF A MATRIX

(71) Applicant: VALEO SYSTEMES THERMIQUES, Le Mesnil Saint-denis (FR)

(72) Inventors: Jean-Louis Lanard, Feucherolles (FR); Issmail Meskin, Le Mesnil Saint-Denis (FR)

(73) Assignee: Valeo Systemes Thermiques, Le Mesnil Saint Denis (FR)

(21) Appl. No.: 14/437,302

(22) PCT Filed: Oct. 22, 2013
(86) PCT No.: PCT/EP2013/072036

§ 371 Date: Apr. 21, 2015

(30) Foreign Application Priority Data
Oct. 25, 2012 (FR) 1260195

(51) Int. Cl. B29C 70/54; B29C 70/48

(52) U.S. Cl. CPC B29C 70/541; B29C 70/48; B29K 2105/0809

(57) ABSTRACT

A method for molding a composite material, the associated mold and a retention frame are disclosed. The method involves tighenting a fiber fabric which forms a reinforcement in a retention frame, the fiber fabric which is tightened in the retention frame is put into place in a mold, and the retention frame is retracted in a receptacle with a corresponding form, of the mold, injecting a matrix into the mold such as to impregnate the fiber fabric to obtain the composite material, and withdrawing the composite material and the retention frame from the mold.

The present invention relates to a method for molding a composite material, of the type comprising a matrix which hardens during molding, and a fiber fabric reinforcement.

Composite materials with a resin-type matrix which hardens during molding with a fiber fabric reinforcement are usually obtained by over-molding the fabric which forms the reinforcement by means of the resin which forms a matrix.

This over-molding takes place in a mold, generally in two complementary parts, which form respectively opposite surfaces of the part required. The fiber fabric, which is generally pre-impregnated, is initially preheated, which increases its deformability. It is then transported to the mold, for example by means of grippers, and is put into place in one of the parts of said mold.

The mold is then closed by putting the second part of the mold into place, which contributes towards putting the fiber fabric into place. The matrix is then injected into the mold, and hardened, for example by cooling or by cross-linking.

A problem can arise during the displacement of the fiber fabric, which in particular is pre-impregnated, when it is reheated. In fact, putting it into place in the mold can lead to the formation of a fold in said fabric. In addition, the preheated fabric tends to adhere to itself in the event of folding caused by the fold.

Folds of this type detract from the quality of the material obtained, in that an end portion of the molded part can then be without a reinforcement, and in that the excess thickness which they constitute is compressed during the molding. This excess thickness is then impregnated less well with the matrix, and may impede the penetration of said matrix in a portion of the mold which is situated beyond the fold relative to the point of injection of the matrix.

These effects contribute to embrittlement of the part obtained made of molded composite material.

In order to reduce the risk of folding of the fiber fabric which forms a reinforcement, said fabric is usually handled carefully and slowly, thus leading to a loss of efficiency in the production cycle, and causing partial cooling of the fabric before it reaches the mold.

In order to fulfil at least partially the aforementioned need, the subject of the invention is a method for molding a composite material, characterized in that it comprises steps in which:
a fiber fabric which forms a reinforcement is tightened in a retention frame;
the fiber fabric which is tightened in the retention frame is put into place in a mold, and the retention frame is retracted in a receptacle with a corresponding form, of the mold;
a matrix is injected into the mold such as to impregnate the fiber fabric in order to obtain the composite material;
the composite material and the retention frame are withdrawn from the mold.

The method for molding a composite material thus implemented makes it possible, by means of use of the frame, to decrease greatly the probability of formation of a fold in the fiber fabric which forms a reinforcement of the composite material.

Said method can have one or more of the following characteristics, taken alone or in combination.

It also comprises an additional step between the tightening of the fiber fabric on the retention frame and the step of putting into place in the mold, wherein the fiber fabric tightened on the retention frame is preheated.

It comprises an additional step between the step of putting into place in the mold and the step of removal from the mold, wherein attachments of the retention frame are separated from the fiber fabric.

It comprises an additional step of adjustment of the tension of the fiber fabric by using means for adjustment of the tension of the fiber fabric supported by the frame.

It also comprises a preliminary step of assembly of the fiber fabric from a plurality of fabric elements disposed according to the structural needs of the composite material required.

The various elements of the fabric differ from one another by at least one of the following characteristics: their thickness, their density, their material, their prior treatment, their stacking.

The fiber fabric comprises one of the following materials: glass fibers, carbon fibers, aramid fibers.

The matrix comprises one of the following materials: thermoplastic resin, epoxide resin, vinyl ether, polyamide, polyester.

The invention also relates to the mold for molding an associated composite material, wherein said composite material comprises a fiber fabric reinforcement and an injectable hardening matrix, comprising two complementary parts which define an injection space in which the composite material is molded, characterized in that it also comprises a receptacle which surrounds an injection space for a retention frame forming a support for the fiber fabric, which frame is designed to be retracted in said receptacle during the molding.

Finally, the invention also relates to the associated retention frame, which is designed to form a support for a fiber fabric forming a reinforcement for a composite material, said retention frame comprising an outer frame forming an outer contour which is designed to surround the fiber fabric, and supporting a certain number of attachments which are designed to render the fiber fabric and the retention frame integral, said retention frame being designed to be retracted in a receptacle in a mold in which the composite material is molded.

In particular, the retention frame can consist of welded metal bars.

Said frame can also or alternatively comprise arms which are supported by the outer frame, and point towards the interior of the latter, and at the end of which attachments are placed.

The attachments can comprise grippers, needles or hooks, as well as an activating mechanism which controls the release of the fiber fabric by the attachment, said mechanism being configured to release the fiber fabric during the molding.

The arms can comprise means for adjustment of the tension of the fiber fabric.

Other characteristics and advantages of the invention will become more apparent from reading the following description, provided by way of non-limiting illustration, and from the accompanying drawings in which:

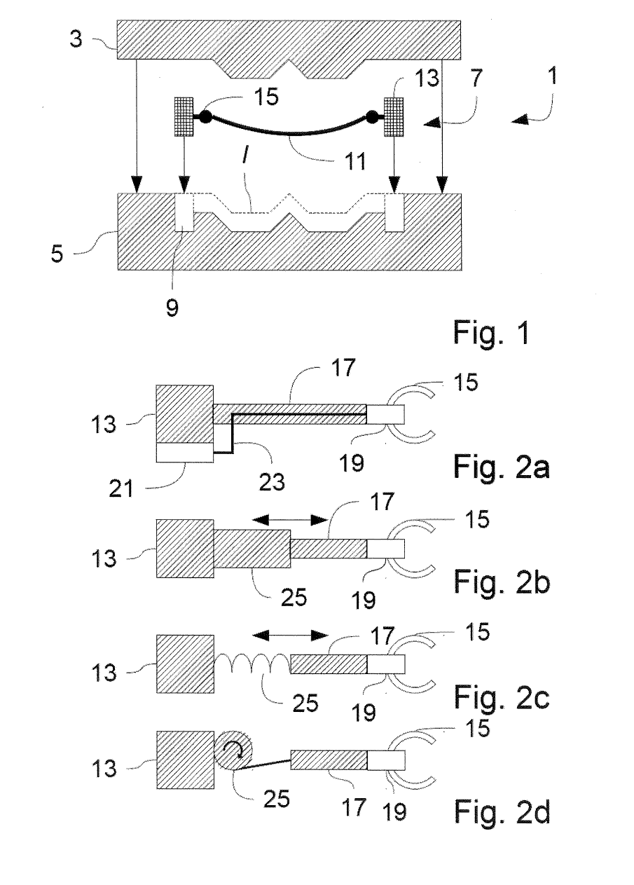

FIG. 1 shows schematically a mold for molding of a composite material part according to the invention ;

FIGS. 2a to 2d show different embodiments of attachments for a frame according to the invention;

FIG. 3 shows schematically a fiber fabric tightened on a frame according to the invention; and

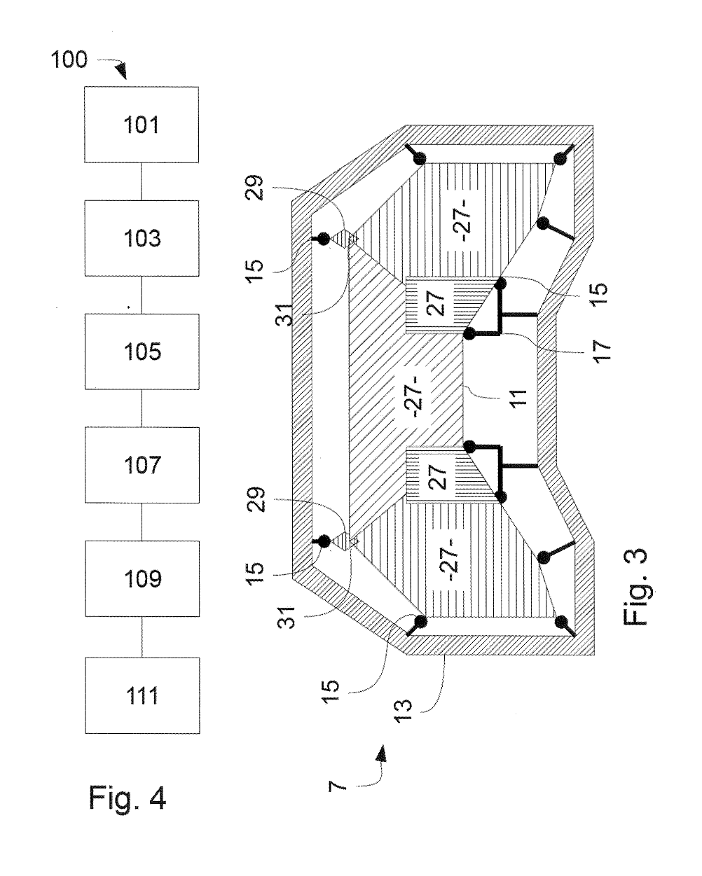

FIG. 4 shows a simplified schematic flow diagram including the main steps of an embodiment of the method according to the invention.

In all the figures, the same references relate to the same elements.

FIG. 1 shows schematically a mold 1 for molding of a composite material by injection of a matrix which hardens on a fiber fabric reinforcement.

Said mold 1 comprises two parts 3, 5 with complementary forms, between which the molding takes place in an injection space I which the complementary forms of the two parts 3, 5 delimit in the assembled state.

A retention frame 7 is associated with the mold 1. Said mold 1 comprises on at least one of its parts 3, 5 a receptacle 9 in which the retention frame 7 is designed to be retracted during the molding. The receptacle 9 is in particular disposed such that the frame surrounds the injection space I when it is retracted.

In particular, the receptacle 9 can be shared between the two parts 3, 5, with a part of the frame 7 being retracted into each of the parts 3, 5 when they are assembled for the molding.

In the frame 7, a fiber fabric 11 is tightened, forming the reinforcement of the composite material. The fiber fabric 11 is for example a fabric of long and laminated or calendered glass fibers, a carbon fiber fabric, an aramid fiber fabric, or a fabric of any other form of fibers known to a person skilled in the art.

The matrix can comprise one or more of the following materials: thermoplastic resin, epoxide resin, vinyl ether, polyamide, polyester, or any other material known to a person skilled in the art for use as a composite material matrix.

The retention frame 7 comprises an outer frame 13, which for example consists of welded or attached metal bars forming an outer contour which is designed to surround the fiber fabric 11. The outer frame 13 supports a certain number of attachments 15, optionally at the end of arms 17 which are attached to the outer frame 13 and point towards the interior of said outer frame 13.

The attachments 15 can for example be grippers, needles, or hooks. At least some of these attachments 15 are in particular configured to open during the molding of the composite material.

In particular, at least one portion of the attachments 15 can be configured to open between the moment of the insertion of the retention frame 7 in the receptacle 9 in the mold 1, and the moment when the composite material is extracted from the mold 1.

For example, the opening can take place during the respective putting into place of the parts 3, 5 of the mold 1 in order to form the injection space I during the injection of the matrix, during the separation of the parts 3, 5, or during the removal of the molded composite material from the mold 1, or after one or more further methods of production of a part from the molded composite material, such as cooling, or application of paint or varnish.

FIGS. 2a to 2d show different embodiments of arms 17 and attachments 15.

FIGS. 2a to 2d show an arm 17, starting from a portion of outer frame 13 of the frame 7 seen in cross section, and an attachment 15 at the end of the arm 17, represented schematically in the form of a gripper.

In FIG. 2a, the attachment 15 comprises an activating mechanism 19 which is connected to a control unit 21. The activating mechanism 19 is situated near the attachment 15, whereas the control unit 21 is advantageously disposed on the frame 7, and thus at a distance from the injection space I.

The mechanism 19 and the control unit 21 are connected by an activating line 23, which is configured to transmit the activation of the control unit 21 to the activating mechanism 19.

In particular, the control unit 21 can comprise a connection to activators (not represented) which are supported by the mold 3, 5 at the receptacle 9.

The control unit 21 initiates the release of the fabric 11 by activating the activating mechanism 19, said mechanism controlling the release of the fiber fabric 11 by the attachment, said mechanism being configured to release the fiber fabric 11 during the molding, so that the fiber fabric 11 is put into place in the mold, which can comprise hollows and bosses, without the fabric being subjected to additional tensions which can lead to its rupture.

For example, the activating mechanism can comprise a servo-motor or piezoelectric elements which give rise to opening of the attachment when they are switched on. The control unit 21 is then a controlled supply, and the activating line 23 is then an electric line which conveys a supply current of the control unit 21 to the activating mechanism 19.

As an alternative, the activating mechanism 19 can comprise levers which are connected to a Bowden cable which forms the activating line 23. The control unit 21 can then comprise a connection at the opposite end of the Bowden cable, thus permitting activation from the activators supported by the mold 1.

FIGS. 2b to 2d show embodiments of arms 17 and attachments 15 comprising means 25 for adjustment of the tension of the fiber fabric 11.

In FIG. 2b, said means 25 for adjustment of the tension comprise a portion of telescopic arm 17: a portion of the arm 17 is a hollow tube in which another part of the arm 17 is accommodated. The length of the arm 17 is then controlled by displacement, for example by means of a servo-motor, a jack system, or a screw pitch, in order to adjust the tension of the fiber fabric 11 accordingly.

In FIG. 2c, said means 25 for adjustment of the tension comprise a resilient portion of arm 17: a section of the arm 17 is replaced by resilient means, such as, for example, a helical spring. The rigidity constant of said resilient means 25 and their elongation during the molding permit control of the tension of the fiber fabric 11.

In FIG. 2d, said means 25 for adjustment of the tension comprise a cable and a winder: a section of the arm 17 is replaced by a cable, for example a metal cable, and a winder makes it possible to control the length of the arm 17 by winding or unwinding of the cable. In this case, the winder is represented at the base of the arm 17, but as an alternative it can be incorporated in the frame 7.

FIG. 3 shows in greater detail a fiber fabric 11 tightened on a retention frame 7. The fiber fabric 11 comprises a plurality of elements 27 consisting of an equivalent number of pieces of fabric with different fibers, which, when correctly assembled, form the fiber fabric 11 which is designed to form the composite material reinforcement. These elements 27 of the fiber fabric 11 can differ in the nature or orientation of their fibers, their thickness, the nature of their prior treatment, their arrangement, and/or they can be obtained by stacking a plurality of layers of fiber fabric.

In particular, the fabric elements 27 can be differently laminated, calendered or pre-impregnated.

The fabric elements 27 make it possible to adapt the local structural properties of the molded part to the stresses encountered in use. For example areas where strong stresses are expected can have a double reinforcement thickness.

An area subjected to strong stresses can also be reinforced with stronger and potentially more expensive fibers, such as aramid fibers. By only reinforcing the fiber fabric 11 locally, the additional cost generated by the stronger materials used for the reinforcement is limited.

Areas of this type which are subjected to strong stresses are for example the areas around a fastener such as a screw or rivet, areas where an impact or external force is probable, areas which are subjected to torsion or pressure, etc. Additional parts such as eyelets, plastic or metal plates, reinforcement rods or cables can also be put into place on the fiber fabric 11 which is tightened in the retention frame 7, in order for these parts to be overmoulded by the matrix.

The fiber fabric 11 can also comprise temporary retention tongues 29 which extend from the periphery of said fiber fabric 11, and are connected to the attachments 15. The tongues 29 are designed to be cut after the molding, for example by cutting, shearing, or breaking after impregnation and then rubbing down.

In particular, the mold 1 can be formed so as to prevent or reduce the impregnation of the fibers of the tongues 29 during molding by compressing them, so that said tongues 29 can be cut more simply.

Said tongues 29 can be connected to the portion of fiber fabric 11 which forms the molded part by a constriction 31 which is narrower than the tongue 29 itself, thus forming a pre-cut which facilitates the subsequent detachment of the tongue 21.

FIG. 3 shows in a simplified flow diagram an embodiment of the molding method 100 for a composite material part.

The first step 101 is the tightening of the fiber fabric 11 in the frame 7. This tightening is carried out for example by means of attachments 15, which are connected to pre-established points of the fiber fabric 11.

During a second step 103, which is optional according to the method used, the fiber fabric 11 supported by the frame 7 is preheated in order to soften it, in particular by melting a resin or thermoplastic pre-impregnation substance, which can optionally be that used to form the composite material matrix.

The third step 105 consists of putting the frame 7 and the fiber fabric 11 into place in the mold 1, for example by placing the frame 7 at least partially in the receptacle 9, and supporting the fiber fabric 11 against one of the parts 3, 5 of the mold 1, and in particular in the injection space between the two parts 3, 5.

The fourth step 107 consists of closure of the mold 1 and injection into the injection space I of the thermoplastic or resin matrix, thus impregnating the fiber fabric 11 in order to form the composite material.

The fifth step 109 is a step of removal of the retention frame 7, if the frame 7 and the composite material obtained have not been separated during the molding. This step 109 can comprise the release of attachments 15 which have not been opened during the preceding steps of putting the frame 7 into place in the mold 1, or of injection of the matrix.

The sixth and final step 111 is a finishing step. This step comprises any further processing at the output of the mold 1, for example the cutting of tongues 21 and rubbing down of the edges of the composite material part.

If the attachments 15 leave undesirable holes, these are then filled in once more, and if they leave needles or other elements lost by immersion in the mass, these are cut short so that they do not project. If on the other hand the attachments 15 leave protuberances, these are removed, for example by rubbing down, or they are flattened by heating and local remolding.

The molding method 100 according to the invention thus makes it possible to obtain a molded part made of composite material more quickly, and with a lower risk of formation of a fold of the fiber fabric 11 which forms a reinforcement during the molding 100 and its preparatory steps (preheating of the fabric 11 and putting into place in the mold 1).

1. A method for molding a composite material, comprising:
tightening a fiber fabric which forms a reinforcement in a retention frame;
putting the fiber fabric which is tightened in the retention frame into place in a mold;
retracting the retention frame in a receptacle with a corresponding form of the mold;
injecting a matrix into the mold such as to impregnate the fiber fabric to obtain the composite material; and
withdrawing the composite material and the retention frame from the mold.

2. The method as claimed in claim 1, further comprising, between the tightening of the fiber fabric on the retention frame and the step of putting into place in the mold, preheating the fiber fabric tightened on the retention frame.

3. The method as claimed in claim 1, further comprising, between putting into place in the mold and removal from the mold, separating attachments of the retention frame from the fiber fabric.

4. The method as claimed in claim 1, further comprising adjusting of the tension of the fiber fabric by using means for adjustment of the tension of the fiber fabric supported by the frame.

5. The method as claimed in claim 1, further comprising a preliminary step of assembly of the fiber fabric from a plurality of fabric elements disposed according to the structural needs of the composite material required.

6. The method as claimed in claim 5, wherein the various elements of the fabric differ from one another by at least one of the characteristics selected from the group consisting of: thickness, density, material, prior treatment, and stacking.

7. The method as claimed in claim 1, wherein the fiber fabric comprises one of the materials selected from the group consisting of: glass fibers, carbon fibers, and aramid fibers.

8. The method as claimed in claim 1, wherein the matrix comprises one of the materials selected from the group consisting of: thermoplastic resin, epoxide resin, vinyl ether, polyamide, polyester.

9. A mold for molding a composite material, said composite material having a fiber fabric reinforcement and an injectable hardening matrix, the mold comprising:
two complementary parts which define an injection space in which the composite material is molded; and
a receptacle which surrounds an injection space for a retention frame forming a support for the fiber fabric, wherein the retention frame is retracted in said receptacle during the molding.

10. A retention frame configured to form a support for a fiber fabric forming a reinforcement for a composite material, said retention frame comprising:
an outer frame forming an outer contour which is designed to surround the fiber fabric, and supporting a certain number of attachments which render the fiber fabric and the retention frame integral,
said retention frame being designed to be retracted in a receptacle in a mold in which the composite material is molded.

11. The retention frame as claimed in claim 10, wherein the outer frame consists of welded metal bars.

12. The retention frame as claimed in claim 10, further comprising arms which are supported by the outer frame, and point towards the interior of the latter, and at the end of which attachments are placed.

13. The retention frame as claimed in claim 12, wherein the attachments comprise grippers, needles or hooks.

14. The retention frame as claimed in claim 12, wherein the attachments comprise an activating mechanism which controls the release of the fiber fabric by the attachment, said mechanism being configured to release the fiber fabric during the molding.

15. The retention frame as claimed in claim 11, wherein the arms comprise means for adjustment of the tension of the fiber fabric.
